(19) United States
(12) Patent Application Publication
(10) Pub. No.: US 2016/0297110 A1
(43) Pub. Date: Oct. 13, 2016

(54) Cooling device of print head in 3D printer

(71) Applicant: Fuzhou ZhanXu Electronic Co.ltd., Fuzhou (CN)

(72) Inventor: Huai WU, Fuzhou (CN)

(73) Assignee: FUZHOU ZHANXU ELECTRONIC CO.LTD., Fuzhou (CN)

(21) Appl. No.: 14/731,411

(22) Filed: Jun. 5, 2015

(30) Foreign Application Priority Data
Apr. 9, 2015 (CN) 201520210278.1

(51) Int. Cl. B29C 35/16; B29C 67/00

(52) U.S. Cl. CPC B29C 35/16; B29C 67/0055; B29C 67/0085; B33Y 30/00

(57) ABSTRACT

The invention relates to a cooling device of print head in 3D printer, including a print head, the print head is set through a slider of the 3D printer by earrings and sliding axially, the cooling device is integrated in the print head. The internal of the housing cavity of print head is provided with a wire transporting mechanism, the axial direction of one side of the housing cavity have set up a cooling fan which is aim at the wire transporting mechanism. The lower part of the housing cavity is provided with a nozzle of the print head, and there is a wind pipe setting into the housing cavity and interconnecting to the nozzles of the print head. The present invention improves the head dissipation of the print head in 3D printer, makes the work space further reduced, and help to improve the portability of the 3D printer.

### TECHNICAL FIELD

The invention relates to the field of the printer, especially relates to a cooling device of print head in 3D printer.

### TECHNICAL BACKGROUND OF THE INVENTION

3D printer is a print appliance to transfer three-dimensional design computer model data into solid models currently, the fused deposition modeling technology is the mainstream 3D printer print technology that the precision of molding except by the impact of driving accuracy, but also to some extent by the precision of feeding, As the nozzle of the print head from the feeding cavity of the print head is so close that the high temperature easily spread the outside of the housing through the housing cavity of the print head when the material melting. If the temperature of housing cavity of the print head is too high, the printed material locating on the feeding portion of the print head will begin to soften, so feeding accuracy is affected thereby affecting the printer's molding accuracy, and if printed material due to the high temperature come into melting in the feeding portion of the print head, the material melted easily plug the print head bringing about the printer malfunction. How does not affect the functionality of the original premise of the print head to improve heat dissipation of the print head of the 3D printer, it is a research direction.

The cooling of the the extruding molten material of the nozzle of traditional 3D printer generally carry out by a fan, the fan is fixed to the side of the nozzle, the wind blows over the molten material straight, so the fan need to form an angle with the print head, the print head in the printing process driven fan synchronized movement, this fan design increases the space occupied by the print head at work, the folding design of 3D printer, which can be reduced as part of the space occupied, and Will effectively enhance the portability of a folding 3D printer.

The patent of Publication No. CN203651217U discloses an Multi-field cooling device of 3D printer, the housing of print head is by a fan for cooling, but this way only for cooling the outer surface of the print head, airflow is not formed inside the housing cavity of the print head, when the wall of the print head housing is thick, easy to make the print head housing inside and outside uneven heating, inside of the print head may lead to be overheating.

### SUMMARY OF THE INVENTION

In order to overcome the shortcoming of the current technique, the main purpose of this invention is provides with a cooling device of print head in 3D printer, can effectively strengthen the cooling of the print head in 3D printers, while reducing the space occupied by the print head at work.

To achieve the above purpose, the technology proposal of this invention is: a cooling device of print head in 3D printer, the print head is set through the slider of the 3D printer by earrings and sliding axially, the cooling device is integrated in the print head, wherein: the internal of the housing cavity of print head is provided with a wire transporting mechanism, the axial direction of one side of the housing cavity have set up a cooling fan which is aim at the wire transporting mechanism. The lower part of the s the housing cavity is provided with a nozzles of the print head, and there is a wind pipe setting into the housing cavity and interconnecting to the nozzles of the print head.

Further, the wire transporting mechanism is driven by a motor, some locating holes are set in the upper of the top plate of the housing cavity to let the wire input, the motor and the cooling fan are respectively disposed on opposite sides of the housing cavity in the axial direction, the wind pipe is set on the baseboard of the housing and near the lower side of the motor, limiting by the top plate and the baseboard of the housing, airflow in the housing cavity of print head blowing in by the cooling fan exhaust through the wind pipe to the nozzles of the print head.

Further, the sidewall of the housing cavity of print head is provided with some through holes for fixing the cooling fan, the outlet of the cooling just opposite the through holes, and by a detachably structure fixedly connect the cooling fan and the through holes.

Further, the beginning of the wind pipe is connected with the housing cavity of print head, the ending of the wind pipe adjacent to the nozzle of the print head, and the outlet of the ending of the wind pipe is pointing to the below of the discharge port of the nozzles of the print head.

Further, the upper end of the nozzles of the print head attached a throat pipe, which is extending into the housing cavity of print head, the beginning of the throat pipe near to the wire transporting mechanism, the ending of the throat pipe is fixedly connected with the nozzle of the print head, the pipe wall of the throat pipe is connected to a plurality of cooling blocks, the cooling blocks are made of metal material and adjacent to the wind pipe.

Further, the cooling block is fixed to the bottom surface of the housing cavity of print head, the adjacent site of the throat pipe and the cooling block have opened a micro air vents, the number of the wind pipes is two, and is respectively located on both sides of the throat pipe.

Further, a dust network is set on the cooling fan, and the cooling fan has a fan failure alarm device, the outer flank of the wind pipes provided LED lights.

Further, below the print head is provided with a print platform, the print platform comprises a movement table moving on the slide guide, the movement table is provided with a mounting plates that is used to place workpieces, both sides of the movement table is provided with a holders for holding the mounting plate, the holders comprises a base block for supporting the mounting plate and a baffle setting up the outside of the base block, the inner side of the baffle extends a convex bar, the below edge of the convex bar fasten on the respective side edge of the mounting plate.

Further, a convex part is set up the base block, the side of the mounting plate is provided with a groove matching with the convex part, the upper surface of the mounting plate is above the upper surface of convex part, the height of the upper surface of the inside of the base block is taller than its outside of the base block, the outside of the baffle extends transversally a pressing handle, below of the movement table is provided with a sliding support matching with the slide guide, the bottom of the holders is connected with the sliding support by springs, and a bolt with highly adjustment run through the holders and the sliding support, a bolt nut is embedded in the middle of the sliding support for cooperating with highly adjustment; the peripheral portion of the movement table has a corner along downwardly extending edge, the sidewall of the sliding support has a embossment, and a slot matching with the embossment is set into the corner, the cross section of the sliding support is terrace, the corner is fastened to the sidewall of the upper terrace floor of the sliding support, the springs is set on the terrace floor of the sliding support, the movement table is connected with the sliding support by bolted connection, the bolt disposed in the middle of the convex part, the spring is provided with a pair and respectively disposed on both sides of the bolt.

In this present invention, the sidewall of the housing cavity of print head is provided with some through holes for fixing the cooling fan, the housing cavity of print head is connected with the wind pipes, the cooling fan is located at the through hole and align the wire transporting mechanism locating inside the print head. This structure of the cooling fan, through hole, the housing cavity of the print head and wind pipes constitute a complete air duct, the outside cold air is blown directly into the cavity of the print head, after flowing through the wire transporting mechanism for cooling, flowing out from the wind pipes. Due to the high efficiency of the active cooling and the cooling fan blowing straight to the wire transporting mechanism enables the printing material locating on the wire transporting mechanism is difficult to soften or melt because of overheating.

In this present invention, the cooling fan is directly provided on the through holes of the print head, the cooling fan blowing cooling air flowing through the housing cavity and then flowing through the wind pipes and sent to the end of materials extrusion of the nozzle, to make the extruded molten material cooling in order to accelerate the speed of the solidify. Only one fan to complete cooling the body of the print head and printed materials, this design directly reduces space of the fan, the working space of the print head is reduced, it benefits further improvement of folding and portability of the 3D printer.

This present invention uses a cooling fan for active cooling, and the direction of the wind toward the housing cavity of print head, air pressure generated by the fan allows cold air into the housing cavity pressure difference, namely the air pressure of the inside housing cavity of print head is greater than its outside, that allows the airflow from the air duct outflow, but also can enter into other gaps forming of the connection of the housing cavity of print and outside, such as input hole of print material, nozzle hole, and so on, effectively improve the cooling, and its internal and external pressure difference also make the hot air formed by the deposited molten material at the outlet of the nozzle is not easy to pass the housing cavity print head.

In this present invention, the wind pipes is provided at the print head, the beginning of the wind pipes is connected with the housing cavity of print head, the ending of the wind pipes adjacent to the nozzle of the print head, and the outlet of the ending of the wind pipe is pointing to the below of the discharge port of the nozzles of the print head. Compared with the conventional cooling fan, the cooling airflow of the wind pipes is more concentrated, the output of the airflow of the wind pipes can highly concentrated cool the deposited molten material at the outlet of the nozzle, the curing rate of the molten material can be improved further, that is very favorable to improve the printing precision and print efficiency.

In this present invention, the upper end of the nozzles of the print head attached a throat pipe, which is extending into the housing cavity of print head, the beginning of the throat pipe near to the wire transporting mechanism, the cooling blocks are made of metal material. Since the metal thermal conductivity faster, the heat of melted portion below the nozzle pass from the nozzle to the throat pipe, and can quickly go to the cooling blocks, since the wind of the cooling fan toward, the cold air can cool the cooling blocks too, so that the temperature of the throat pipe connected with the cooling block can be reduced, and the transporting of the printing material from the wire transporting mechanism to the nozzle not to overheat, the wind pressure in the housing cavity formed of the cooling fan can squeeze the cold air into throat pipe to further enhance the cooling effect.

The beginning of the wind pipe adjacent to the cooling blocks, so that the cooling air in the housing cavity mostly concentrated in the cooling blocks and flow out from the lateral of the cooling blocks, which strengthened the air flow around the cooling blocks, and make heat of the cooling blocks can be quickly take away.

This product has a dust network at the cooling fan to filter dust, airflow before entering the housing cavity of the print head was cleaned by the dust network, it make not deposit dust on the housing cavity of the print head.

This product has fan failure alarm device in the cooling fan, when the cooling fan failure, timely warning and timely troubleshooting allowing users to further enhance the reliability of the product.

The sidewall of the housing cavity of print head is provided with some through holes for fixing the cooling fan, the cooling fan fix on the sidewall of the housing cavity of print head by a detachably structure, Since large diameter of the cooling fan, so the diameter of the through hole is large, which makes the simple maintenance of the components in the housing cavity of print head can be performed by the through hole after removing the fan, thereby improve the maintenance efficiency.

The housing cavity of the print head by a input positioning plate of the wire, outer wall of the motor and the outer wall of the housing together form a air cofferdam, the cooling airflow is mainly discharged from the wind pipes, ensure wind pipes to the print position of the bottom of the nozzle have enough cooling airflow, and such a structure to ensure the shell of print head strength while making the print head is easy to disassemble, easy to maintain, the air between each member of the air cofferdam enclosure can facilitate easy flow of cooling air inside and outside, and on the whole reducing the volume of the print head, help enhance the folding portable of the 3D printer.

The sidewall of the wind pipes have provided with a LED lights, so that the user can observe the curing and cooling process of the molten material more clearly, in order to accurately assess the effect of the cooling device.

The adjacent site of the throat pipe and the cooling blocks have opened a micro air vents. The air inside the housing cavity come into being a airflow in micro air vents from inside to out side under the action of air pressure, it is conducive to the airflow of cooling blocks and the throat pipes, and benefits the cooling of the throat pipe and the cooling blocks.

The number of the wind pipes is two, and is symmetrically located on both sides of the throat pipe, the extruded molten material of nozzle is subjected to two directions of the cooling airflow for cooling, make the curing of material more uniform and curing faster.

### BRIEF DESCRIPTION OF THE DRAWINGS

According to the following drawings to make further explain the present invention.

FIG. 1 is a front schematic view of the product according to the present invention;

FIG. 2 is a front cutaway schematic view of the present invention the product;

FIG. 3 is a schematic view of a three-dimensional product according to the present invention;

FIG. 4 is a side schematic view of the product working by the conveyor belt according to the present invention;

FIG. 5 is a schematic diagram of the housing of the product according to the invention;

FIG. 6 is a schematic diagram of the wind pipes of the product according to the invention;

FIG. 7 is a schematic diagram of the wire transporting mechanism of the product according to the invention;

FIG. 8 is the product with a print platform according to the invention;

FIG. 9 is the structure diagram of the mounting plates matching with the holders in the place of A in FIG. 7;

FIG. 10 is the structure diagram of the end of the base block provided with a protuberance;

FIG. 11 is the structure diagram of the upper of the base block arranged in an inclined way.

FIG. 12 is the top view of the FIG. 8;

FIG. 13 is the structure diagram of the mounting plates matching with the holders in FIG. 12;

FIG. 14 is a schematic cross-sectional view B-B in FIG. 12.

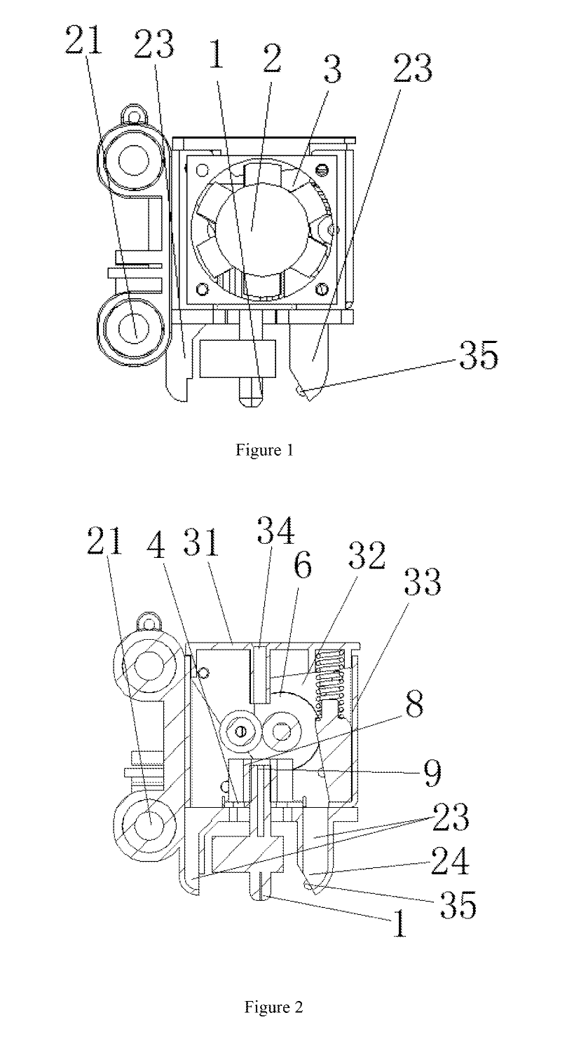

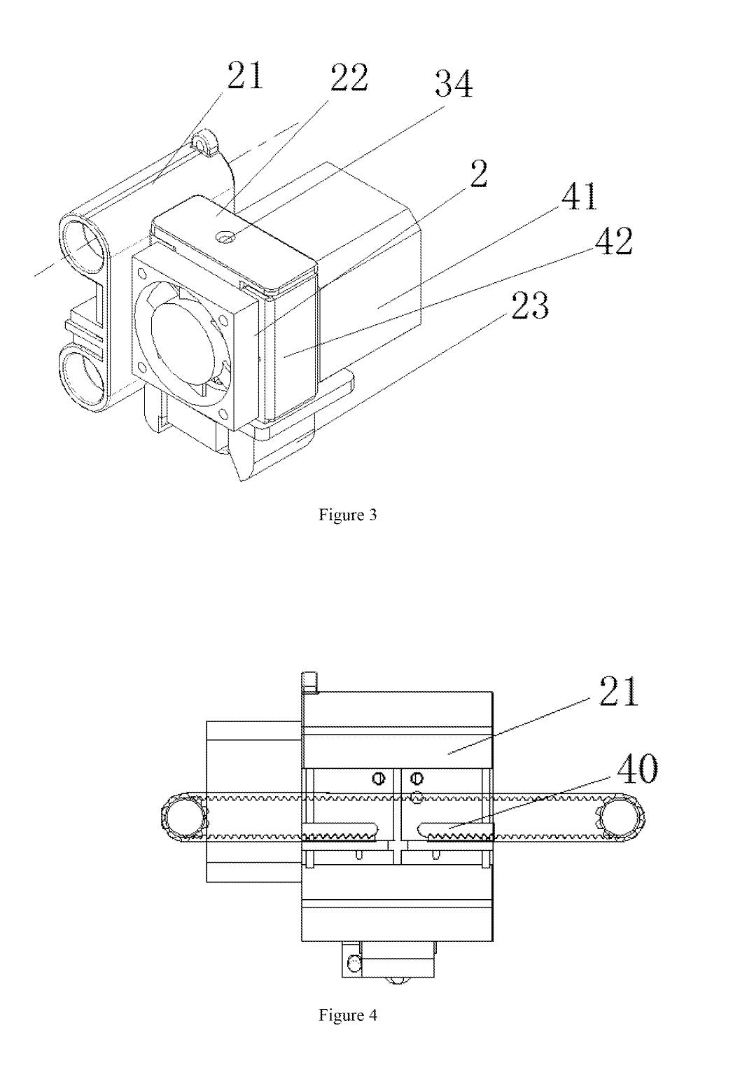

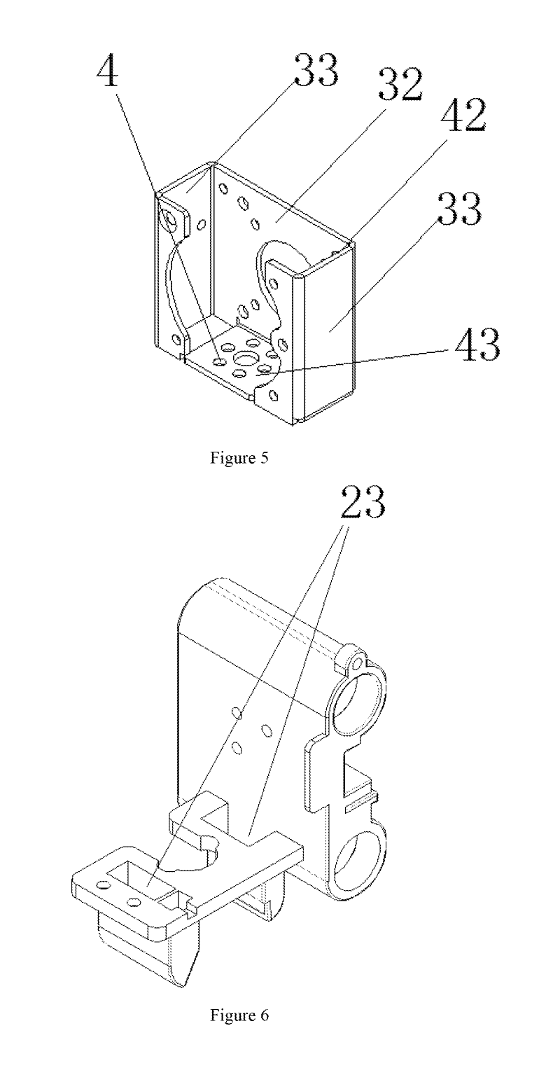

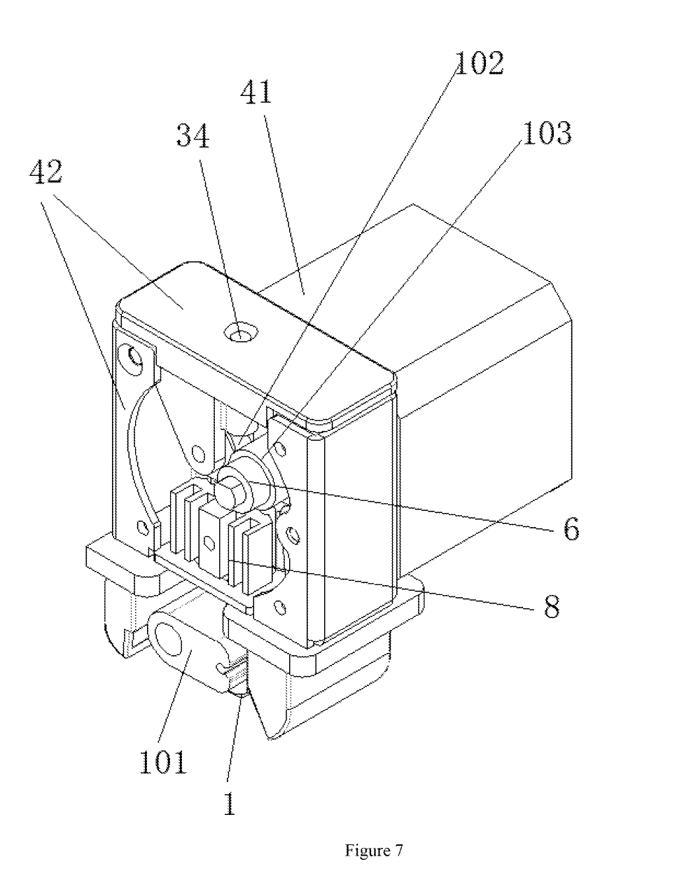

### DETAILED DESCRIPTION OF THE PREFERRED EMBODIMENT

Referring to the above Figures, the present invention provide a preferred embodiment which is a cooling device of print head in 3D printer, the print head 11 is set through the slider 10 of the 3D printer by earrings 21 and sliding axially, the cooling device is integrated in the print head 11, the internal of the housing cavity 22 of print head is provided with a wire transporting mechanism 6, the axial direction of one side of the housing cavity 22 have set up a cooling fan 2 which is aim at the wire transporting mechanism 6, The lower part of the s the housing cavity 22 is provided with a nozzles 1 of the print head, and there are some wind pipes 23 setting into the housing cavity 22 and interconnecting to the nozzles 1 of the print head.

The wire transporting mechanism 6 is driven by motor 41 installing outside of the housing 42, some locating holes 34 are set in the upper of the top plate of the housing cavity 22 to let the wire input, the motor 41 and the cooling fan 2 are respectively disposed on opposite sides of the housing cavity 22 along the axial direction, the wind pipes 23 are set on the baseboard of the housing 42 and near the lower side of the motor 41, limiting by the top plate and the baseboard of the housing 42, airflow in the housing cavity 22 of print head blowing in by the cooling fan 2 exhaust through the wind pipes 23 to the nozzles 1 of the print head.

The sidewall of the housing cavity 22 of print head is provided with some through holes 3 for fixing the cooling fan 2, the outlet of the cooling fan 2 just opposite the through holes 3, and by a detachably structure fixedly connect the cooling fan 2 and the through holes 3.

The beginning of the wind pipes 23 are connected with the housing cavity 22 of print head, the ending of the wind pipes 23 adjacent to the nozzle 1 of the print head, and the outlet of the ending 24 of the wind pipes 23 are pointing to the below of the discharge port of the nozzles 1 of the print head.

Further, the upper end of the nozzles 1 of the print head attached a throat pipe 9, which is extending into the housing cavity 22 of print head, the beginning of the throat pipe 9 near to the wire transporting mechanism 6, the ending of the throat pipe 9 is fixedly connected with the nozzle 1 of the print head, the pipe wall of the throat pipe 9 is connected with a plurality of cooling blocks 8, the cooling blocks 8 are made of the metal material and adjacent to the wind pipes 23.

Said housing cavity 22 of the print head also has a heating mechanism 101 for heating the printing material, the heating mechanism 101 is located below the wire transporting mechanism 6 of the print head; upper of the housing 42 offers some locating holes 34 that can access to the wire transporting mechanism 6 of the print head, so that the print material can enter into the wire transporting mechanism 6 of the print head according to a predetermined location, below the housing 42 has provided the nozzles 1 for outputting the printing material, and the nozzles 1 is located under the heating mechanism 101. The wire transporting mechanism 6 includes a gear pair, the gear pair comprises a driving wheel 103 and a driven wheel 102, and the driving wheel 103 is driven by the motor 41, the driving wheel 103 parallel to the driven wheel 102 and engage with each other, in order to make the printing material output from the throat pipe 9 locating in the middle of the heating mechanism 101 to the nozzles 1.

The cooling blocks 8 are fixed to the bottom surface of the housing cavity 22 of print head, the adjacent site 43 of the throat pipe 9 and the cooling blocks 8 have opened a micro air vents 4, the number of the wind pipes 23 is two, and is respectively located on both sides of the throat pipe 9.

A dust network is set on the cooling fan 2.

The cooling fang has a fan failure alarm device.

The outer flank of the wind pipes 23 provided LED lights 25. The external of the housing cavity 22 of the print head with a rack 40 to install the toothed belt, the print head 11 is driven by the toothed belt and slipping along the slider 10 of the 3D printer. The design of the belt device takes up less space, positioning accuracy and during transmission belts can absorb external shocks, the positioning accuracy is not affected, so that print accuracy less vulnerable to external shocks.

The working principle of the embodiment is: the workers put the printing material across the locating holes 34 and crush the printing material between the driving wheel 103 and driven wheel 102, so that the printing material is clamped by the driving wheel 103 and driven wheel 102. When the wire transporting mechanism 6 work, the the driving wheel 103 of the gear pair is rotatable driving by the motor 41 and to drive the driven wheel 102, so that the printing material clamped by the driving wheel 103 and the driven wheel 102 moves down into the throat pipe 9, and continues to move down to the heating mechanism 101 for heating and melting, finally discharges from the nozzle 1 below the printing material 101 to the printing surface, when the cooling fan 2 is working, the outside cold air is blown into the housing cavity 22 of print head by the through holes 3, and make the outside cold to cool by the heat exchange of wire transporting mechanism 6 and the cooling blocks 8, and outflow form the wind pipes 23 to he housing cavity 22. the cold air is sent under the nozzle 1 of the print head through the wind pipes 23, discharged from outlet of the ending 24 of the wind pipes 23 to make extruded molten material from the nozzle 1 is cooled solidify.

Getting The Cooling fan 2, through hole 3, the housing cavity 22 of print head and the wind pipes 23 together to constitute a air duct, the through hole act as the entrance of the air duck, the ending 24 of the wind pipes 23 act as the outlet of the air duck. The cold air blowing from the fan cooling 2 flow out from the wind pipes limiting by the sidewall 32, the sidewall 33, the top plate 31 and the baseboard of the housing 42, and form the air pressure in the housing cavity 22 of print head at the same time, to promote the airflow and accelerate the discharging of the heat, and because the adjacent site 43 of the throat pipe 9 and the cooling block 8 have opened a micro air vents 4, under the action of the air pressure, at the site of the micro air vents 4 generate a airflow flowing from inside toward outside in housing cavity 22, and conduct heat exchange at the side of throat pipe 9 to prevent its temperature from rising, and to cut off the hot air entering into the print portion. In order to prevent the heat of the molten material extruded by nozzle 1 passing to the housing cavity 22 of print head.

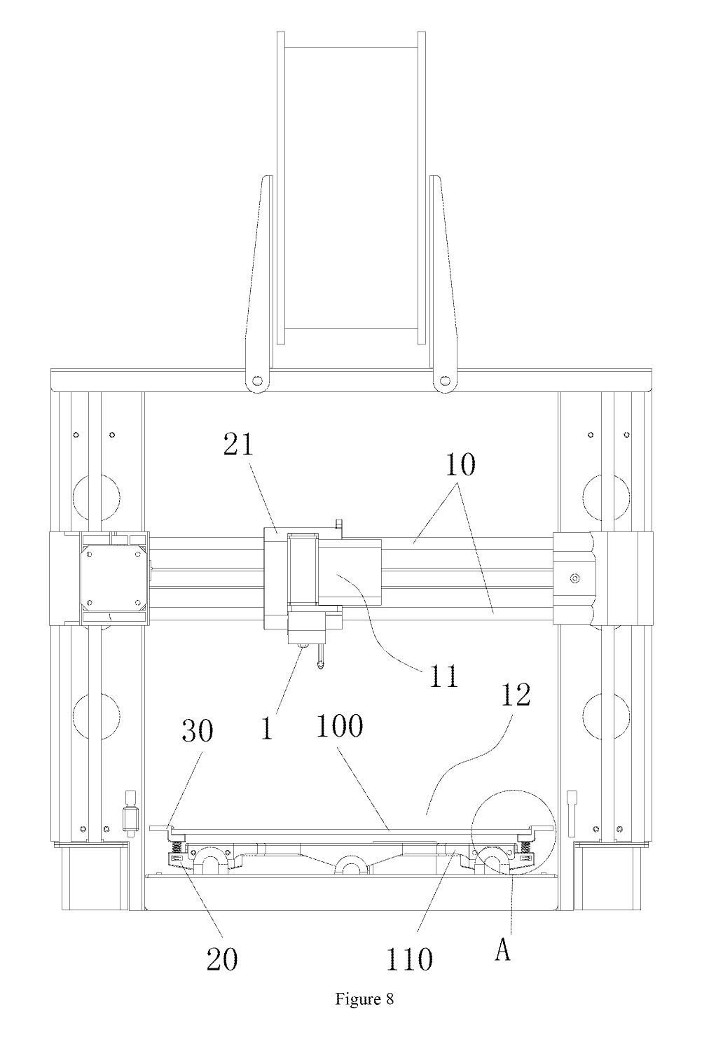

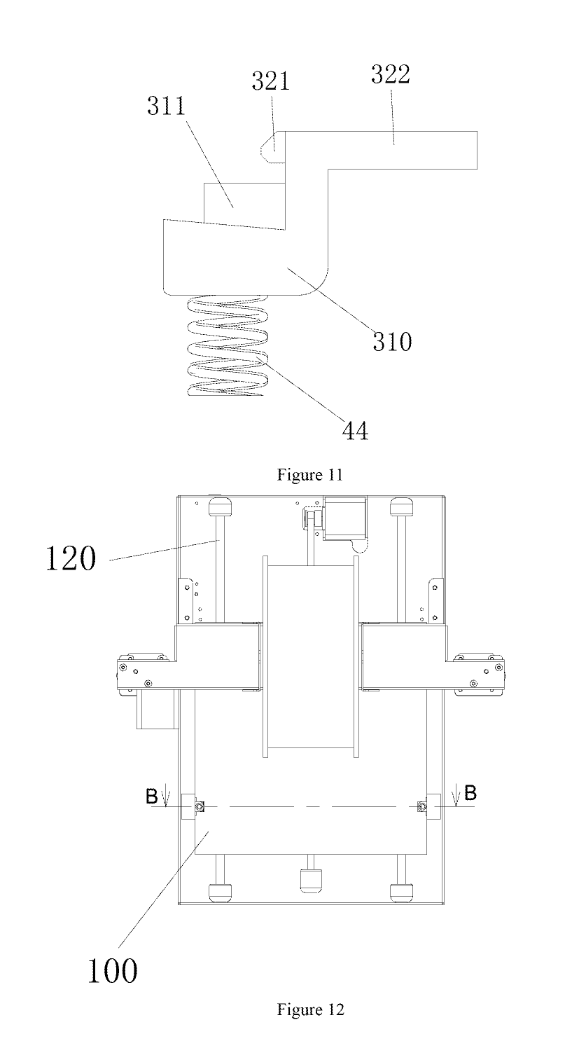

Referring to the FIG. 7-13, below the print head 11 is provided with a print platform 12, the print platform 12 including a movement table 110 moving on the slide guide 120, the movement table 110 is provided with a mounting plates 100 that is used to place workpieces, both sides of the movement table 110 is provided with a holders 30 for holding the mounting plate 100, the holders 30 including a base block 310 for supporting the mounting plate 100 and a baffle 320 setting up the outside of the base block 310, the inner side of the baffle 320 (toward the side of the mounting plates 110) extends a convex bar 321, the below edge of the convex bar 321 fasten on the respective upper side edge of the, mounting plate 100.

In the embodiment, there are four holders 30 located 110 on both sides of the movement table 110, the holders 30 are distributed in the four corners of the position of the mounting plate 100. A convex part 311 is set up the base block 310 of the holderss 30, the side of the mounting plate 100 is provided with a groove 101 matching with the convex part 311. In operation, when the convex part 311 and the groove 101 cooperate to prevent the mounting plate from moving. Preferably, the groove 101 and the convex part 311 assume the rectangular shape, of course, in practical applications can also be trapezoidal or other shaped. The baffle 320 of holders 30 overcomes of the. up and down vibrations of the mounting plate 100.

To facilitate the pressing operation, the outside of the baffle 320 extends transversally a pressing handle 322, the design of the pressing handle 322 can avoid the collision between the baffle 320 and the print head 11. To further enhance the locking force on the mounting plate 100 by the holders 30, the height of upper surface of the inner end of the base block 310 (near the end of the mounting plate 100) is higher than its outer end of the base block 310 (away from end of the mounting plate 100), the scheme allows the edge of the opposite sides of the mounting plate 100 produce the opposite torque, in order to lock the mounting plate 100. The following explanation of its application in accordance with embodiment:

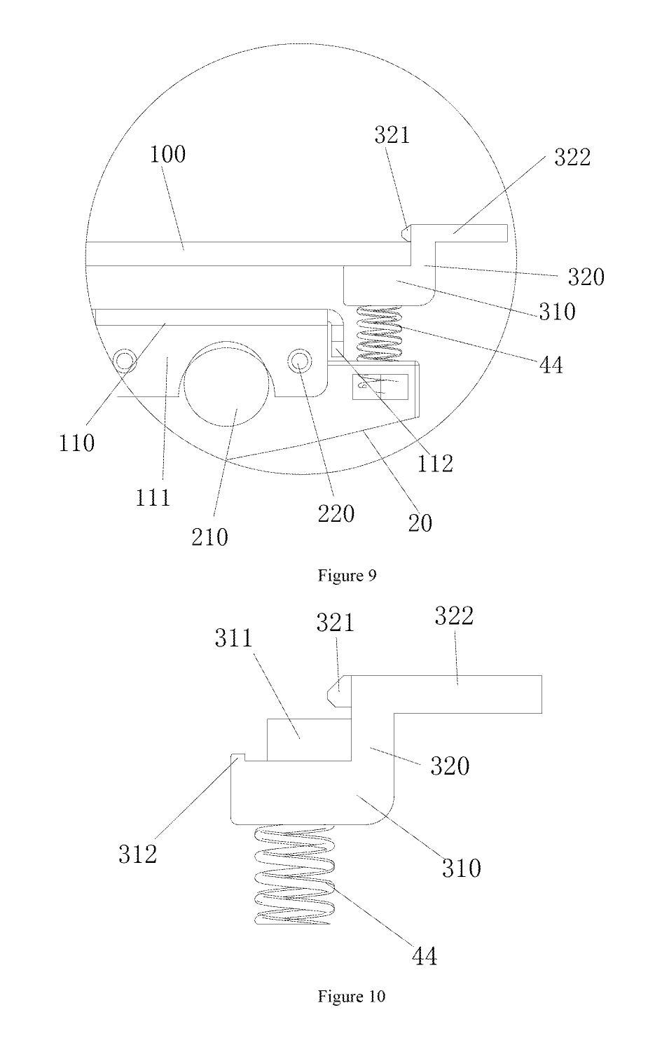

As shown in FIG. 9, the base block 310 provided with a protuberance 312 close to the one end of the mounting plate 100. When the mounting plate 100 is fixed, the convex bar 321 produce a downward force on the mounting plate 100, and the protuberance 312 produce an upward effect on the mounting plate 100, thereby forming a torque to realize the locking of the mounting plate 100.

As shown in FIG. 10, the upper surface of the base block 310 is inclined from one end of approaching the mounting plate 100 to the end of far from the mounting plate 100, When the mounting plate 100 is fixed, the convex bar 321 produce a downward force on the mounting plate 100, and the inclined upper surface of the base block 310 generates an upward force on the mounting plate 100, thereby forming a torque to realize the locking of the mounting plate 100.

In the embodiment, the convex bar 321 provided at both sides of the convex part 311. In the present embodiment, the base block 310, the convex part 311, the baffle 320 and the 321 convex bar integrally. Of course, in the case may be conducive to forming by way of detachable connection.

In the embodiment, below of the movement table 110 is provided with a sliding support 20 matching with the slide guide 120, the central of the sliding support 20 is provided with a through hole 210 for linking the slide guide 120, the upper surface of the sliding support 20 beyond the both sides of the movement table 110. A bolt 50 with highly adjustment run through the holders 30 and the sliding support 20, in the middle of the sliding support 20 open a opening for placing bolt nut 230, the bolt nut 230 is cooperated with the bolt 50 of highly adjustment, and embedded in the opening to avoid the downward prolapsed of the bolt nut 230 when the bolt rotating.

In the embodiment, the sliding support 20 and the movement table 110 are fixedly connected, for example, by the erection of a bolt threaded connection. The peripheral portion of the movement table 110 has a corner (111,112) along downwardly extending edge, the front side or rear side of the sliding support 20 has a embossment 220, and a slot match with the embossment 220 is set into the corner 111 of the movement table 110 to achieve positioning, the cross section of the is terrace, the terrace floor of the sliding support 20 exceed the both side of the movement table 110, the corner 112 of the movement table 110 is fastened to the sidewall of the upper terrace floor of the sliding support 20, the springs 44 is set on the terrace floor of the sliding support, the bottom of the holders is connected with the sliding support by springs 44, the springs 44 can link by fixing the upper end and lower end, also can set up a corresponding recess in the bottom of holders 30 and the terrace floor to accommodate the spring 44 to achieve connection.

In the embodiment, the bolt 50 with highly adjustment disposed in the middle of the convex part 311, there is a sink for placing the bolt 50 with highly adjustment set into convex part 311. When using, the lower end of the bolt 50 with highly adjustment through the holders 30 and enter into the sliding support 20, below the nut of the bolt 50 match with the surface of the sink, the holders 30 against the elastic force of springs 44 by bolting connection to achieve fixed, the spring is provided with a pair and respectively disposed on both sides of the bolt.

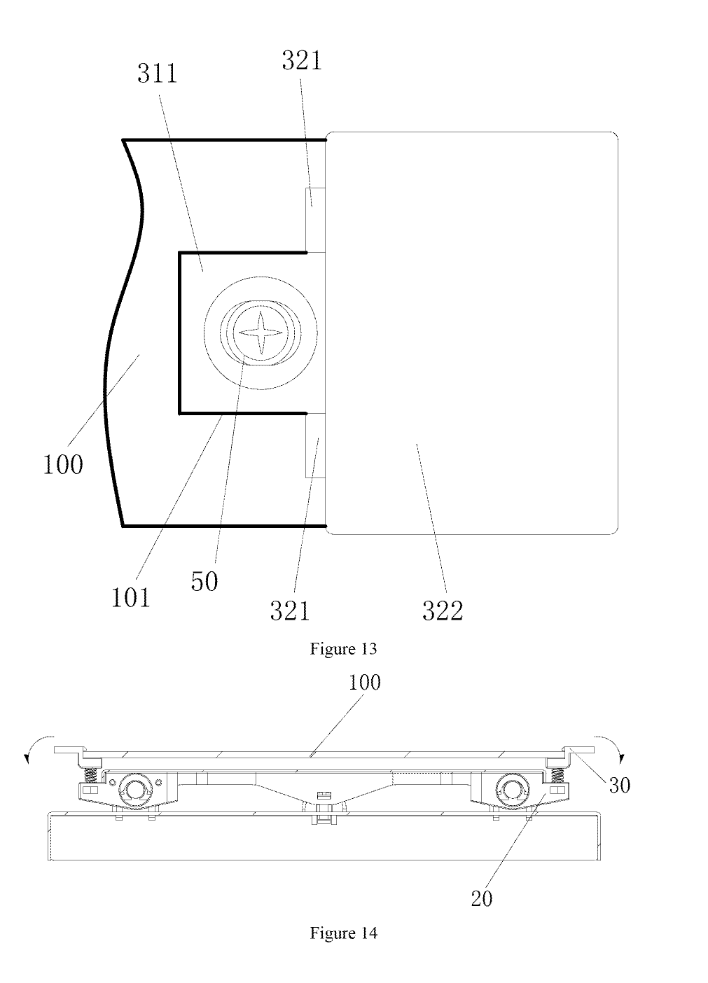

In this invention, the upper surface of the mounting plate 100 exceed the upper surface of the convex part 311, that can effectively avoid the collision between the print head 11 and the convex part 311 during positioning or working. The springs 44 that is to play a supporting role in the holders 30, and can be easily achieve highly adjustment because of the scalability of the springs 44, it help to maintain Further, since the scalability of springs 44, when removing the mounting plate 100, only to breaking off the holders 30 outward (according to the direction of the arrows in FIG. 13) can be separated the mounting plate 100 from the holders 30, it is very convenient.

Print platform of the present invention is advantageous in that:

(1) Between the holders 30 and the mounting plate 100 there has a groove 101 and a convex part 311 cooperating with each other to limit the mounting plate 100 laterally displacing in operation of the 3D printer, using the extension of the convex bar 321 lock the upper surface of the mounting plate 100 to prevent the up and down shaking of the mounting plate 100 from affecting the quality of molding. The holders 30 take the advantage of the characteristics of the springs 44, when the mounting plate 100 need to be removed, only to simply tilt outward can expediently dismantle the mounting plate 100, so conducive to remove the mounting plate 100 after molding the workpieces.

(2) The holderss 30 take advantage of the downward force on the mounting plate 100 producing by the convex bar 321 and the taller surface of the base block 310 approaching the end of the mounting plate 100 to produce a torque on the edge of the mounting plate 100, and further improve the locking force on the mounting plate 100 by the holderss 30 to ensure that it does not happen shaking or loosing in the long running of the 3D printer.

(3) The design of the taller surface in the end of the mounting plate 100 provide a margin compensation due to a long-term wearing between the lateral of the mounting plate 100 and the convex bar 321, greatly improve the life of the mounting plate 100 and the holders 30.

(4) The holders 30 also can adjust the height of the mounting plate 100, taking advantage of the interworking of the springs 44 and the bolt 50 with highly adjustment to adjust the height of the mounting plate 100 and improve the accuracy of the adjustment and the product molding effect.

(5) The sliding support 20 through the cooperation of the embossment 220 and the movement table 110 to ensure the limiting and easy installation of the movement table 110.

(6) The upper surface of the mounting plate 100 is overtop the upper surface of the convex part 311 it is effective to avoid the collision with the convex part 311 produced during the positioning or working of the print head 11.

1. A cooling device of print head in 3D printer, comprising:
a print head, wherein the print head is set through a slider of the 3D printer by earrings and sliding axially;
a cooling device integrated in the print head;
wherein the internal of a housing cavity of the print head is provided with a wire transporting mechanism;
wherein the axial direction of one side of the housing cavity have set up a cooling fan which is aim at the wire transporting mechanism;
wherein the lower part of the housing cavity is provided with a nozzle of the print head, and there is a wind pipe setting into the housing cavity and interconnecting to the nozzle of the print head.

2. The cooling device of print head in 3D printer according to claim 1,
wherein the wire transporting mechanism is driven by a motor;
wherein a plurality of locating holes are set in the upper of a top plate of the housing cavity to let the wire input;
wherein the motor and the cooling fan are respectively disposed on opposite sides of the housing cavity in the axial direction;
wherein the wind pipe is set on a baseboard of the housing cavity and near the lower side of the motor, limited by the top plate and the baseboard of the housing cavity;
wherein an airflow in the housing cavity of print head blowing in by the cooling fan exhaust through the wind pipe to the nozzle of the print head.

3. The cooling device of print head in 3D printer according to claim 1, wherein a sidewall of the housing cavity of the print head is provided with a plurality of through holes for fixing the cooling fan;
wherein an outlet of the cooling fan is set just opposite the through holes, and a detachably structure fixedly connects the cooling fan with the through holes.

4. The cooling device of print head in 3D printer according to claim 1, wherein the beginning of the wind pipe is connected with the housing cavity of the print head;
wherein the ending of the wind pipe is adjacent to the nozzle of the print head, and the outlet of the ending of the wind pipe is pointing to the below of the discharge port of the nozzle of the print head.

5. The cooling device of print head in 3D printer according to claim 1, wherein the upper end of the nozzle of the print head is attached with a throat pipe, which is extending into the housing cavity of the print head;
wherein the beginning of the throat pipe is near to the wire transporting mechanism, the ending of the throat pipe is fixedly connected with the nozzle of the print head;
wherein the pipe wall of the throat pipe is connected to a plurality of cooling blocks, which are made of metal material and adjacent to the wind pipe.

6. The cooling device of print head in 3D printer according to claim 5, wherein the cooling block is fixed to the bottom surface of the housing cavity of the print head;
wherein the adjacent site of the throat pipe and the cooling block have opened a micro air vents;
wherein the number of the wind pipes is two, and is respectively located on both sides of the throat pipe.

7. The cooling device of print head in 3D printer according to claim 1, wherein a dust network is set on the cooling fan;
wherein the cooling fan has a fan failure alarm device;
wherein the outer flank of the wind pipes is provided with a plurality of LED lights.

8. The cooling device of print head in 3D printer according to claim 1, wherein a print platform is provided below the print head the print platform comprises a movement table moving on the slide guide, and the movement table is provided with a mounting plate that is used to place workpieces;
wherein both sides of the movement table is provided with a plurality of holders for holding the mounting plate;
wherein each of the holders comprises a base block for supporting the mounting plate and a baffle setting up the outside of the base block;
wherein the inner side of the baffle extends a convex bar, the below edge of the convex bar fasten on the respective side edge of the mounting plate.

9. The cooling device of print head in 3D printer according to claim 8, wherein a convex part is set up the base block, the side of the mounting plate is provided with a groove matching with the convex part;
wherein the upper surface of the mounting plate is above the upper surface of convex part, the height of the upper surface of the inside of the base block is taller than its outside of the base block;
wherein the outside of the baffle extends transversally a pressing handle;
wherein below of the movement table is provided with a sliding support matching with the slide guide;
wherein the bottom of the holder is connected with the sliding support by a spring, and a bolt with highly adjustment run through the holder and the sliding support, a bolt nut is embedded in the middle of the sliding support for cooperating with highly adjustment;
wherein the peripheral portion of the movement table has a corner along downwardly extending edge;
wherein the sidewall of the sliding support has an embossment, and a slot matching with the embossment is set into the corner, the cross section of the sliding support is terrace, the corner is fastened to the sidewall of the upper terrace floor of the sliding support;
wherein the spring is set on the terrace floor of the sliding support, the movement table is connected with the sliding support by a bolted connection, the bolt is disposed in the middle of the convex part, the spring is provided with a pair and respectively disposed on both sides of the bolt.
